(19) United States
(12) Patent Application Publication
(10) Pub. No.: US 2025/0342127 A1
(43) Pub. Date: Nov. 6, 2025

(54) CIRCULAR QUEUE MANAGEMENT WITH NONDESTRUCTIVE SPECULATIVE READS

(71) Applicant: Akeana, Inc., Santa Clara, CA (US)

(72) Inventor: Nagesh Suranna Kanakapura, Sunnyvale, CA (US)

(73) Assignee: Akeana, Inc., Santa Clara, CA (US)

(21) Appl. No.: 19/194,185

(22) Filed: Apr. 30, 2025

Related U.S. Application Data
(60) Provisional application No. 63/640,921, filed on May 1, 2024.
(60) Provisional application No. 63/641,045, filed on May 1, 2024.
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.

(51) Int. Cl. G06F 13/16; G06F 9/38

(52) U.S. Cl. CPC G06F 13/1621; G06F 9/38585; G06F 13/1673

(57) ABSTRACT

Techniques for managing computer processors that implement speculative reads are disclosed. A circular queue is accessed. The circular queue comprises a plurality of entries and includes a head pointer and a tail pointer. The head pointer and the tail pointer move independently in a single direction within the circular queue. A software agent selects a read entry associated with a read index within the circular queue. A validity of the read entry is interpreted based on a head wrap bit, a tail wrap bit, a read index, a head index, and a tail index. The circular queue returns an invalid signal to the software agent. The read entry is not modified when the read entry is interpreted as invalid. The circular queue sends data within the read entry to the software agent. The head wrap bit is calculated to be equal to the tail wrap bit.

### RELATED APPLICATIONS

This application claims the benefit of U.S. provisional patent applications “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, and “Accelerated TAGE Branch Prediction With A TAGE Cache” Ser. No. 63/795,829, filed Apr. 28, 2025.

Each of the foregoing applications is hereby incorporated by reference in its entirety.

### FIELD OF ART

This application relates generally to computer processors and more particularly to circular queue management with nondestructive speculative reads.

### BACKGROUND

Efficient reading and writing of data in a processor are crucial for several reasons. Efficient data handling directly impacts the overall performance of the processor. Reading and writing data quickly allows the processor to perform computations faster, leading to improved system responsiveness and reduced processing times. Furthermore, efficient data handling helps in optimizing the utilization of resources such as memory and storage. It ensures that these resources are not unnecessarily occupied for extended periods, which can lead to better resource management and overall system efficiency. Additionally, efficient data handling reduces the chances of data corruption or loss during read and write operations. This is important for maintaining data integrity, especially in mission-critical applications where data accuracy is paramount. Moreover, reading and writing data inefficiently can have the adverse consequence of increased power consumption, especially in mobile and battery-powered devices. Conversely, efficient data handling can help reduce power consumption, leading to longer battery life and improved energy efficiency.

Main categories of processors include Complex Instruction Set Computer (CISC) types, and Reduced Instruction Set Computer (RISC) types. In a CISC processor, one instruction may execute several operations. The operations can include memory storage, loading from memory, arithmetic operations, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

The efficiency of a processor is a critical factor influencing the performance, power consumption, and overall user experience of modern products. Efficient processors can have an environmental impact, in that lower power consumption translates to reduced energy usage, which can have a positive impact on the environment by lowering carbon emissions and reducing the overall demand for energy. Furthermore, efficient processors can provide improved scalability, which is beneficial for both small-scale devices and large-scale computing systems. In particular, efficient reading and writing of data in a processor are essential for achieving optimal performance, resource utilization, power efficiency, data integrity, and support for concurrency in modern computing systems.

### SUMMARY

Circular queues, also referred to as ring buffers or circular buffers, play a crucial role in processors and embedded systems. Circular queues are used to efficiently manage data streams and queues with fixed, often limited, memory space. Circular queues can enable efficient storage of sequential data in a continuous memory block. Instead of moving data around when new elements are added or removed, the circular queue can use a fixed-size buffer that wraps around when it reaches its end, mimicking a circular structure. Circular queues can be used as First-In-First-Out (FIFO) data structures. New data is written at one end (the “tail”), and old data is read from, and removed from the other end (the “head”), maintaining the order in which data entered the queue. In real-time systems, circular queues are used to buffer data between processes or devices that operate at different speeds. This buffering helps to synchronize data flow and to prevent data loss due to overwriting. Circular queues can be implemented efficiently in software or hardware, often using simple arithmetic operations for indexing instead of complex memory allocation and deallocation routines. This makes them suitable for resource-constrained environments like embedded systems. Circular queues have utility in audio and video processing, networking protocols, device drivers, and other systems where a continuous stream of data needs to be processed or stored.

Techniques for managing computer processors that implement speculative reads are disclosed. A circular queue is accessed. The circular queue comprises a plurality of entries and includes a head pointer and a tail pointer. The head pointer and the tail pointer move independently in a single direction within the circular queue. A software agent selects a read entry associated with a read index within the circular queue. A validity of the read entry is interpreted based on a head wrap bit, a tail wrap bit, a read index, a head index, and a tail index. The circular queue returns an invalid signal to the software agent. The read entry is not modified when the read entry is interpreted as invalid. The circular queue sends data within the read entry to the software agent. The head wrap bit is calculated to be equal to the tail wrap bit.

A processor-implemented method for managing a queue is disclosed comprising: accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue; selecting, by a software agent, a read entry within the circular queue, wherein the read entry is associated with a read index; interpreting a validity of the read entry, wherein the interpreting is based on the head wrap bit, the tail wrap bit, the read index, the head index, and the tail index; and returning, by the circular queue, to the software agent, an invalid signal, wherein the read entry is not modified, and wherein the read entry was interpreted, by the interpreting, as invalid. Some embodiments comprise sending, by the circular queue, to the software agent, data within the read entry, wherein the read entry is not modified, and wherein the read entry was interpreted, by the interpreting, as valid. Some embodiments comprise calculating that the head wrap bit is equal to the tail wrap bit, the read index is greater than or equal to the head index, and the read index is less than the tail index. Some embodiments comprise computing that the head wrap bit is not equal to the tail wrap bit and the read index is greater than or equal to the head index. Some embodiments comprise assessing that the head wrap bit is not equal to the tail wrap bit and the read index is less than the tail index.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for circular queue management with nondestructive speculative reads.

FIG. 2 is a flow diagram for interpreting an entry as valid.

FIG. 3 is a block diagram of a multicore processor.

FIG. 4 is a block diagram of a pipeline.

FIG. 5 is a block diagram of pointers for an 8-entry circular queue.

FIG. 6 is a block diagram of circular queue management with similar wrap bits.

FIG. 7 is a block diagram of circular queue management with different wrap bits.

FIG. 8 is a block diagram of valid logic for circular queue management with nondestructive speculative reads.

FIG. 9 is a system diagram for circular queue management with nondestructive speculative reads.

### DETAILED DESCRIPTION

A circular queue is accessed. The circular queue can include multiple entries. The circular queue includes a head pointer and a tail pointer. The head and tail pointers each include an index and a wrap bit. During operation, the wrap bits toggle when the pointers wrap back to the top of the queue. A logic block evaluates the indexes and the wrap bits of the head and tail pointers to determine if a given speculative read contains valid data. If the data requested by a speculative read is valid, the data is copied from the queue without altering its data or validity, thereby creating a nondestructive read. If the data is invalid, an invalid data indication is provided to the software agent that is reading the data.

One important use of circular queues is for handling data consumed and/or produced by interrupt service routines (ISRs) to efficiently handle data coming from or going to external devices. When an external device generates data at a high rate, an ISR can be triggered to handle incoming data. Instead of processing the data directly in the ISR, which can be time-consuming and can affect the responsiveness of the system, the ISR can quickly store the data in circular queues and return it. This enables the main application to process the data at a different rate. Additionally, circular queues help avoid data loss in scenarios where data arrives faster than it can be processed. By storing incoming data in a queue, the ISR ensures that no data is lost even if the main application is busy processing previous data. Furthermore, ISRs are often time-sensitive and should execute quickly. By using circular queues, the ISR can quickly store or retrieve data while decoupling the ISR execution from the timing constraints of the main application. This decoupling allows the ISR to be more responsive and reliable. Circular queues can also be used to synchronize data between ISRs and the main application. For example, an ISR might fill a queue with data, and the main application might process this data when the main application is ready. The circular queue acts as a communication channel between the ISR and the main application, ensuring that data is handled correctly. Circular queues can adapt to varying data rates. If data arrives faster than it can be processed, the queue, if properly sized, can absorb the burst of data while eliminating data loss. The main application can then process the data at a rate that it can handle. This is useful in “bursty” applications, such as the processing of network traffic. Overall, circular queues are a fundamental data structure in processors and embedded systems, providing a simple and efficient way to manage data streams and queues.

Another factor that plays a role in the performance of computing systems is the number of logic gates that implement the processor and associated peripherals. A higher gate count can result in a larger chip size, which increases manufacturing costs. Additionally, more complex designs often require more engineering effort, which can also increase development costs. Furthermore, each logic gate consumes power, and more gates can result in higher power consumption. This can lead to increased heat generation and the need for more complex cooling solutions, which can further increase power consumption. Furthermore, while adding more logic gates can increase the functionality of a processor or System-on-Chip (SoC), it can also introduce delays in signal propagation, which can reduce overall performance. Keeping the gate count low helps maintain a balance between functionality and performance and has several other advantages. For one, complex designs with high gate counts are more prone to logic errors and timing issues. Keeping the gate count low can improve the reliability of the design and reduce the likelihood of errors. Additionally, as the gate count increases, so does the complexity of testing and verification. A reduced gate count makes it easier to ensure that the design behaves as expected under all conditions. Overall, minimizing the logic gate count in a processor or SoC is essential for controlling costs, reducing power consumption, maintaining performance, ensuring reliability, and simplifying testing and verification.

Another important aspect of processor performance is the ability to perform speculative reads. Speculative reads in a processor refer to the ability of the processor to fetch data from memory before it is actually needed, based on predictions about future instructions or data access patterns. If speculative reads are not available, several disadvantages can arise. Without speculative reads, the processor must wait until an instruction explicitly requests data before fetching it from memory. This can result in increased latency, especially for instructions that depend on data that is not already in the processor's cache. Speculative reads can improve performance by allowing the processor to fetch data in advance, reducing the impact of memory access latency. Without speculative reads, the processor may spend more time waiting for data to be fetched, which can reduce overall performance. Moreover, without speculative reads, the processor may encounter stalls where it must wait for data to be fetched from memory before it can continue executing instructions. These stalls can reduce processor throughput and performance. Speculative reads can also help increase instruction-level parallelism by allowing the processor to fetch and execute instructions ahead of time. Without speculative reads, the processor may be more limited in its ability to execute instructions in parallel, further reducing performance. Performing speculative reads from a circular queue creates additional challenges. Typically, when data is read from a circular queue, it is performed as a “destructive” read, in that the data in the location that was read is now invalid (e.g., no longer available).

Disclosed embodiments address the aforementioned issues with circular queues by providing techniques for circular queue management with nondestructive speculative reads. One or more embodiments utilize a head pointer and a tail pointer that each include a corresponding index, as well as a wrap bit. The wrap bits, in conjunction with the indexes, enable an identification of valid and invalid data without an excessive amount of logic gates to support the feature. Moreover, disclosed embodiments enable a nondestructive speculative read. With the nondestructive speculative read of disclosed embodiments, any location of the circular queue may be read in a nondestructive manner. In this way, the contents and validity of the memory location of the circular queue are preserved. Thus, disclosed embodiments enable the capability of speculative reads, which can lead to improved processor performance, while keeping the number of additional gates for the implementation reduced in order to improve efficiency of a processor or SoC.

Techniques for circular queue management with nondestructive speculative reads are disclosed. A circular queue is accessed. The circular queue can include multiple entries. The circular queue includes a head pointer and a tail pointer. The head and tail pointers each include an index and a wrap bit. During operation, the wrap bits toggle when the pointers wrap back to the beginning (top) of the queue. A logic block evaluates the indexes and the wrap bits of the head and tail pointers to determine if a given speculative read contains valid data. If the data is valid, the data is copied from the queue without altering its validity, thereby creating a nondestructive read. If the data is invalid, an invalid data indication is provided to the software process that is reading the data.

The head pointer and tail pointer, with their corresponding indexes and wrap bits, enable a determination of validity of data in the circular queue without needing to examine or alter data in the circular queue itself. This enables a powerful performance enhancement of enabling speculative reads of a circular queue without the need for additional read ports and/or other logic gates that would be needed for direct circular queue inspection. For example, a Peripheral Component Interface Express (PCI Express, or PCI-e) controller can set up transactions where data from a PCI-e device is sending data to a circular queue. The processor can be running software that anticipates the data being sent and can issue reads of the circular queue. If the processor runs instructions out of order, then those read instructions can be presented to the circular queue out of order (that is, the processor can issue speculative reads of the circular queue). Present disclosures present a method for determining the validity of any entry in the circular queue without reading bits stored within the entry or adjusting a head pointer which can result in a destructive read. Thus, disclosed embodiments provide improvements in circular queue management that can enable improved performance while limiting the amount of additional logic gates needed for implementation.

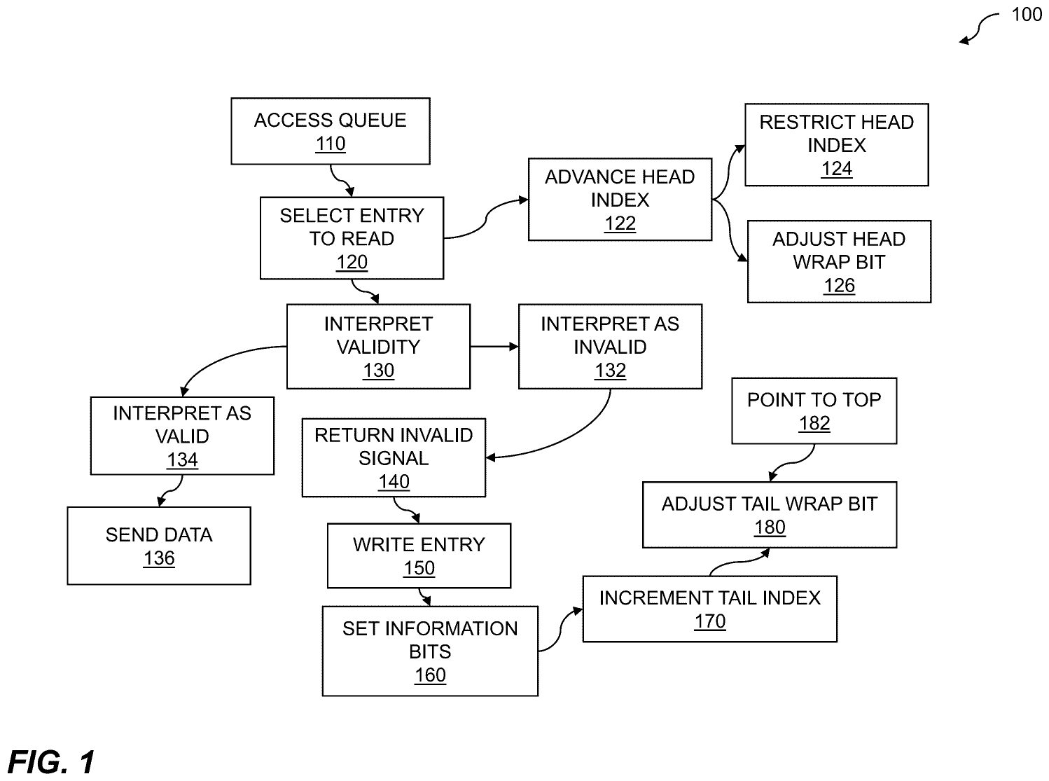

FIG. 1 is a flow diagram for circular queue management with nondestructive speculative reads. The flow 100 includes accessing a queue 110. The queue can be implemented as a circular queue. The queue can have a data width of 8 bits, 16 bits, 32 bits, 64 bits, 128 bits, or any data width. In one or more embodiments, one or more information bits are included for each entry in the circular queue. In embodiments, the one or more information bits are additional bits. As an example, a queue with a data width of 16 bits may have four additional information bits, for a total width of 20 bits, with 16 bits for data, and 4 bits for additional information. A similar concept can be applied for other data widths. For example, the queue can have a data width of 128 bits and 4 bits for additional information, for a total width of 132 bits. In one or more embodiments, the data portion may be reduced to enable byte-aligned boundaries. For example, the queue can have a data width of 60 bits, with 4 bits for additional information, for a total width of 64 bits, enabling byte-aligned data that includes additional information. Embodiments can include accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue.

The flow 100 further includes selecting an entry to read 120. The circular queue can act as a FIFO (First-in-First-Out data structure). For a normal read (e.g., a dequeuing read that occurs at the head pointer), data is read from the circular queue at the location specified by the head index. The flow 100 includes advancing the head index 122 as part of a normal read operation. The flow 100 can include restricting the head index 124. The restricting can include restricting the direction of advancement to a single direction. The restricting can include restricting the head index from overtaking the tail index. Thus, embodiments can include restricting the head index, wherein the restricting prevents the head index from moving past the tail index. When the head index reaches the last buffer location of a circular queue, the next time the head index is advanced, the head index references the first buffer location of the circular queue. The transition from the last buffer location of the circular queue to the first buffer location of the circular queue represents a wrap event. The flow 100 can include adjusting the head wrap bit 126. The adjusting can include a toggle operation, in which case the head wrap bit toggles between a 0 value and a 1 value on subsequent wrap events. Thus, if the head wrap bit is currently set to a value of 0, the head wrap bit toggles to a value of 1 on the next wrap event. Then, on the following wrap event, the head wrap bit toggles back to a value of 0. This process repeats for subsequent wrap events. Embodiments can include selecting, by a software agent, a read entry within the circular queue, wherein the read entry is associated with a read index. In embodiments, the head pointer and the tail pointer move independently in a single direction within the circular queue, except for during a wrap event.

The location may be in valid state, in which case it contains valid data. As part of the process of reading data from the circular queue, the flow 100 includes interpreting 130 a validity of the read entry, wherein the interpreting 130 is based on the head wrap bit, the tail wrap bit, the read index, the head index, and the tail index. In embodiments, the validity is interpreted based on the state of the head wrap bit and the tail wrap bit, as well as the location referenced by the head index and the tail index, and the location within the circular queue that is being read. Thus, in embodiments, the validity of a location of the circular queue can be determined without accessing the circular queue itself. In embodiments, the read can be a speculative read. A speculative read can include any location within the circular queue. The speculative read can read an entry of the circular queue without dequeuing the entry. In embodiments, the entry is dequeued if the read occurs at the entry pointed to by the head pointer. In embodiments, the speculative read is controlled by a software agent. The software agent can adjust a read pointer that can access any location of the circular queue. The read pointer can comprise a read index. The speculative read may be used as part of a data prefetching process. Embodiments can include interpreting a validity of the read entry, wherein the interpreting is based on the head wrap bit, the tail wrap bit, the read index, the head index, and the tail index.

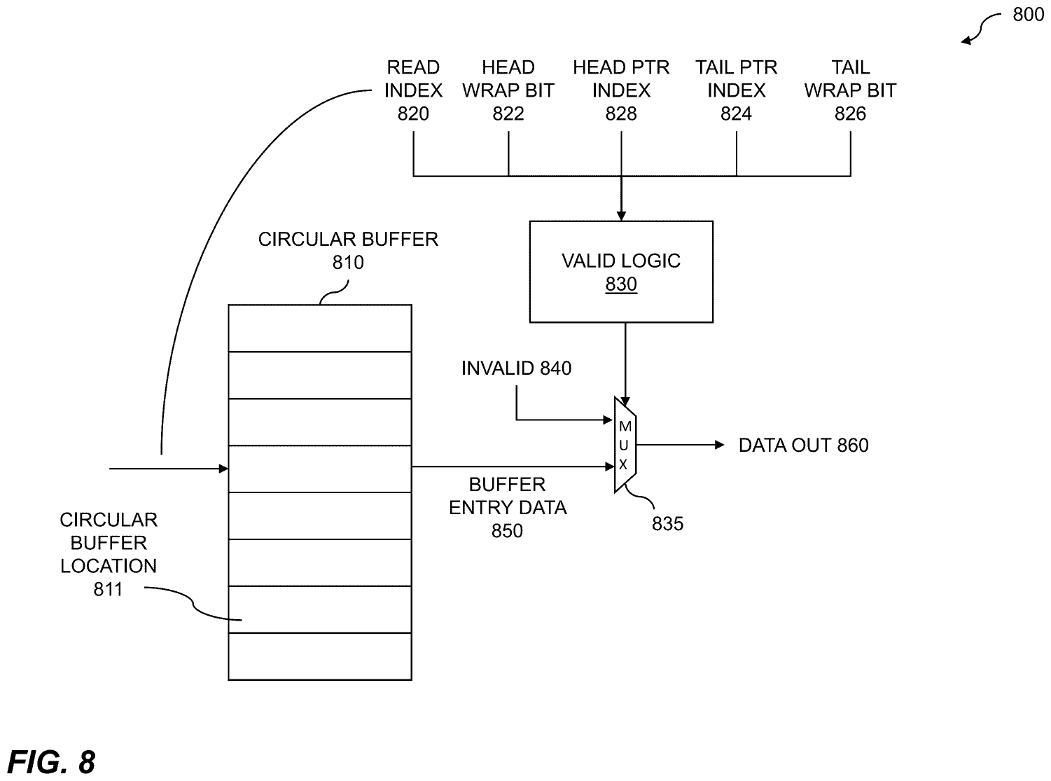

The flow 100 includes interpreting the data being read as valid 134. The interpreting of data in a circular queue location as valid can be based on the state of the head wrap bit and the tail wrap bit, as well as the location referenced by the head index and the tail index, and the location within the circular queue that is being read. The location can be interpreted as valid when the following logical formula is true: [(head wrap bit=tail wrap bit) AND (read index >=head index) AND (read index <tail index)] OR {(head wrap bit !=tail wrap bit) AND [(read index >=head index) OR (read index <tail index)]}. The logical formula can be implemented in the circular queue by logic gates as will be explained in FIG. 8. In response to interpreting the data as valid, the flow 100 can include sending the data 136. If the read is a normal read, the head index is advanced by the software agent, and the data in the location that was read is indicated as invalid. The indication of invalidity of the previously read location of the circular buffer can be based at least in part on the new position of the head index after the normal read.

The flow 100 includes interpreting the data that was read as invalid 132. The interpreting of data in a circular queue location as invalid can be based on the state of the head wrap bit and the tail wrap bit, as well as the location referenced by the head index and the tail index, and the location within the circular queue that is being read. The location can be interpreted as invalid when the following logical condition is met: [(head wrap bit=tail wrap bit) AND (read index <head index OR read index >=tail index)] OR [(head wrap bit !=tail wrap bit) AND (head index !=tail index) AND (read index <head index AND read index >=tail index)].

In response to interpreting the data that was read as invalid, an invalid signal can be returned 140. In one or more embodiments, the invalid signal can include a reserved word or value of data. In one or more embodiments, the invalid signal can include a logic signal. In one or more embodiments, the invalid signal can include and/or be based on information bits. The invalid signal can be stored outside of the circular queue entry and can be selected via a multiplexor when the circular queue determines that an entry is invalid (as will be described in FIG. 8). Embodiments can include returning, by the circular queue, to the software agent, an invalid signal, wherein the read entry is not modified, and wherein the read entry was interpreted, by the interpreting, as invalid.

A tail pointer is used for determining the next location to write data into the circular queue. Similar to the head pointer, the tail pointer also includes an index and a wrap bit. The flow 100 includes writing an entry 150 into the circular buffer. Embodiments can include writing, by a hardware agent, an entry in the circular queue. In one or more embodiments, the writing is based on the tail index. The flow 100 includes setting information bits 160. Thus, embodiments can include setting one or more information bits. In embodiments, the one or more information bits include a type of data. In embodiments, the type of data is read data. In embodiments, the type of data is write data. In embodiments, the type of data is atomic data. The atomic data can include data that cannot be divided or broken down into smaller units of data. In one or more embodiments, the atomic data types can include integers, floating-point numbers, characters, and Boolean values. In embodiments, the type of data is a message. In embodiments, the message can include a memory read request to request data from memory. The message can include a memory write request to write data to memory. The message can include a configuration read message to read configuration information. The message can include a configuration write message to write configuration information. The message can include a flow control message for managing the flow of data between devices, hosts, peripherals, etc. The message can include a completion message to indicate completion of a transaction. Other embodiments may include more, fewer, and/or different types of messages.

After new data is written to a location in a circular queue, the tail index is incremented 170. Thus, embodiments can include incrementing the tail index. The flow 100 includes adjusting the tail wrap bit 180. In embodiments, the adjusting occurs in cases where the tail index is at the end of the buffer that is used for implementing the circular queue. In the case where the tail index is at the end of the buffer, and then gets incremented, the tail index is set to the top (beginning) of the buffer, and the tail wrap bit is adjusted accordingly. The adjusting can include toggling the tail wrap bit. The flow 100 includes setting the tail index to point to a top 182 of a circular queue. Thus, embodiments can include adjusting the tail wrap bit wherein the incrementing causes the tail index to point to a top of the circular queue.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

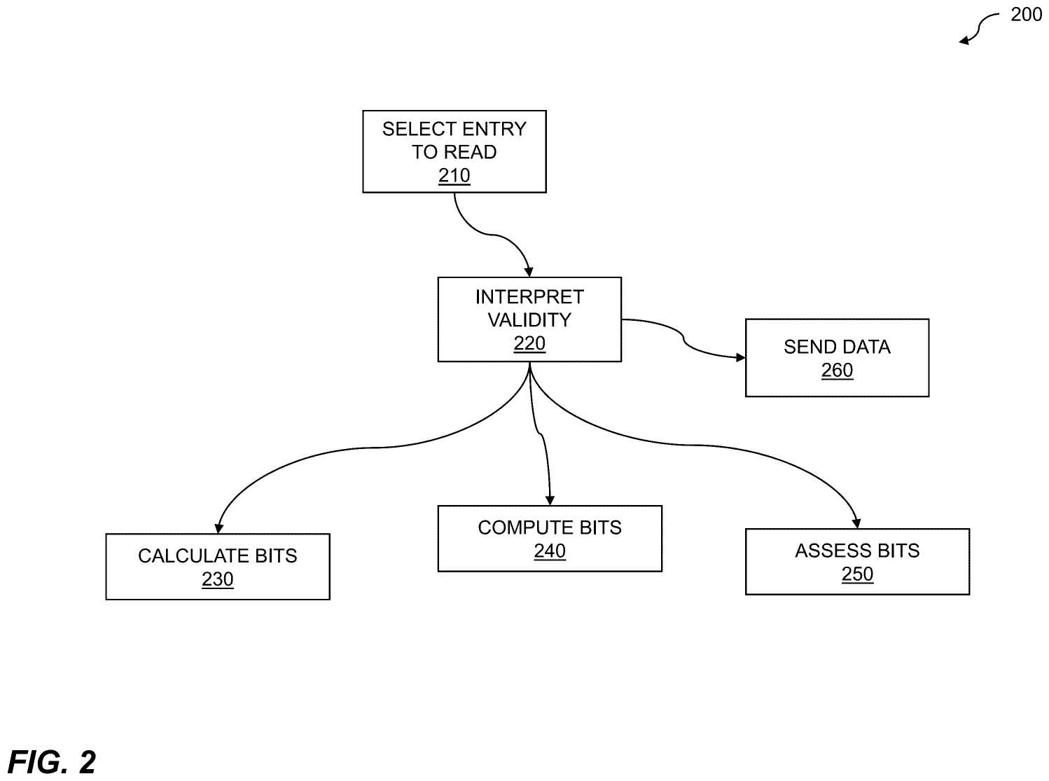

FIG. 2 is a flow diagram for interpreting an entry as valid. The flow 200 includes selecting 210, by a software agent, a read entry within the circular queue, wherein the read entry is associated with a read index. The read can include a normal read that dequeues data from a circular queue. The read entry can include a speculative read. The speculative read can be based on a read index. In embodiments, the speculative read does not dequeue data from the circular queue. The speculative read can include an out-of-order (OoO) read, such as from a PCI-e data transfer operation. The selection of an entry to read can correspond to a particular location within the circular queue. The OoO execution of instructions can be beneficial for performance of processors, including those based on RISC (Reduced Instruction Set Computing) architectures.

The flow 200 can include interpreting the validity 220 of the read entry, wherein the interpreting is based on the head wrap bit, the tail wrap bit, the read index, the head index, and the tail index. Thus, in embodiments, the validity of a location of the circular queue can be determined without accessing the circular queue itself. In embodiments, the read can be a speculative read. A speculative read can include any location within the circular queue. The speculative read can read an entry of the circular queue without dequeuing the entry. In embodiments, the speculative read is controlled by a software agent. The software agent can adjust a read pointer that can access any location of the circular queue. The read pointer can comprise a read index. The speculative read may be used as part of a data prefetching process.

To determine if an entry is valid, the flow 200 can include calculating bits 230. Embodiments can include calculating that the head wrap bit is equal to the tail wrap bit, the read index is greater than or equal to the head index, and the read index is less than the tail index. Logically, this can be expressed as: (head wrap bit=tail wrap bit) AND (read index >=head index) AND (read index <tail index). In embodiments, the calculating can be accomplished with one or more logic gates. To further determine if an entry is valid, the flow 200 can include computing bits 240. Embodiments can include computing that the head wrap bit is not equal to the tail wrap bit and the read index is greater than or equal to the head index. Logically, this can be expressed as: (head wrap bit !=tail wrap bit) AND (read index >=head index). In embodiments, the computing can be accomplished with one or more logic gates. To further determine if an entry is valid, the flow 200 can include assessing bits 250. Embodiments can include assessing that the head wrap bit is not equal to the tail wrap bit and the read index is less than the tail index. Logically, this can be expressed as: (head wrap bit !=tail wrap bit) AND (read index <tail index). In embodiments, the assessing can be accomplished with one or more logic gates.

The flow 200 can include sending data 260. The sending can be based on interpreting data as valid. The destination of the sending can be a software agent, software process, software thread, application, and so on. Thus, embodiments can include sending, by the circular queue, to the software agent, data within the read entry, wherein the read entry is not modified, and wherein the read entry was interpreted, by the interpreting, as valid.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

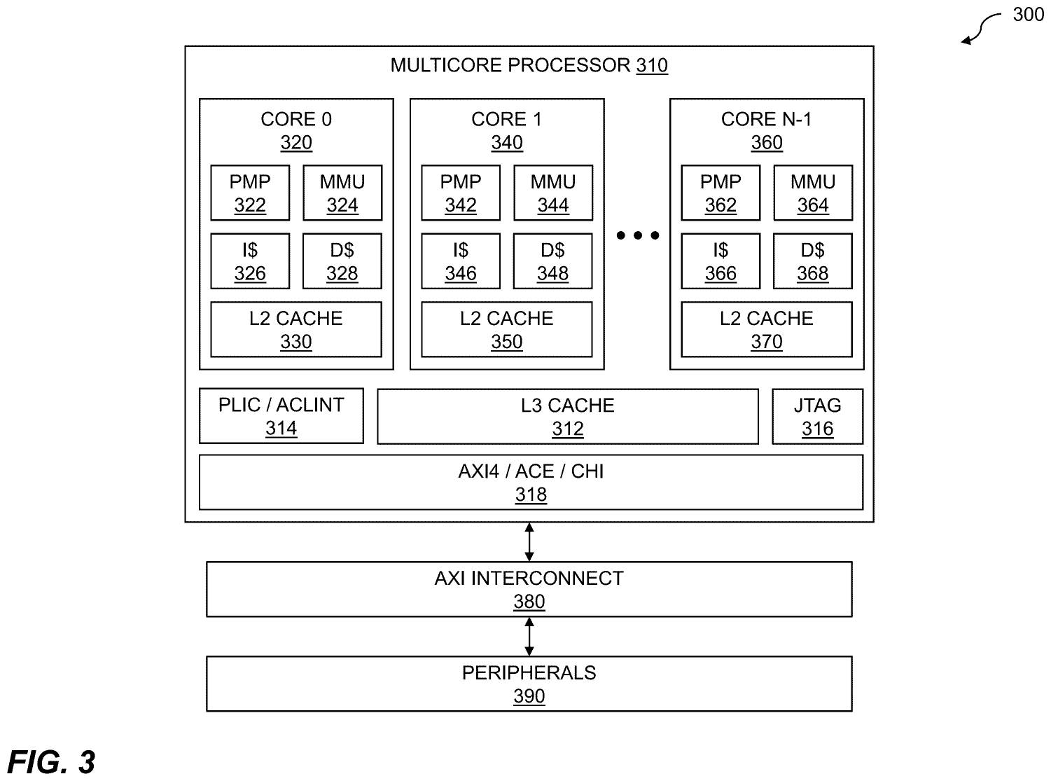

FIG. 3 is a block diagram of a multicore processor. The processor, such as a RISC-V™ processor, ARM processor, or other suitable processor type, can include a variety of elements. The elements can include processor cores including multiprocessor cores, one or more caches, memory protection and management units, local storage, and so on. In embodiments, the processor core sequences vector operations for exception handling. The elements of the multicore processor can further include one or more of a private cache; a test interface such as a joint test action group (JTAG) test interface; one or more interfaces to a network such as a network-on-chip, shared memory, and peripherals; and the like. The multicore processor is enabled by vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1, can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$326 and a data cache D$328 associated with core 0; an instruction cache I$346 and a data cache D$348 associated with core 1; and an instruction cache I$366 and a data cache D$368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

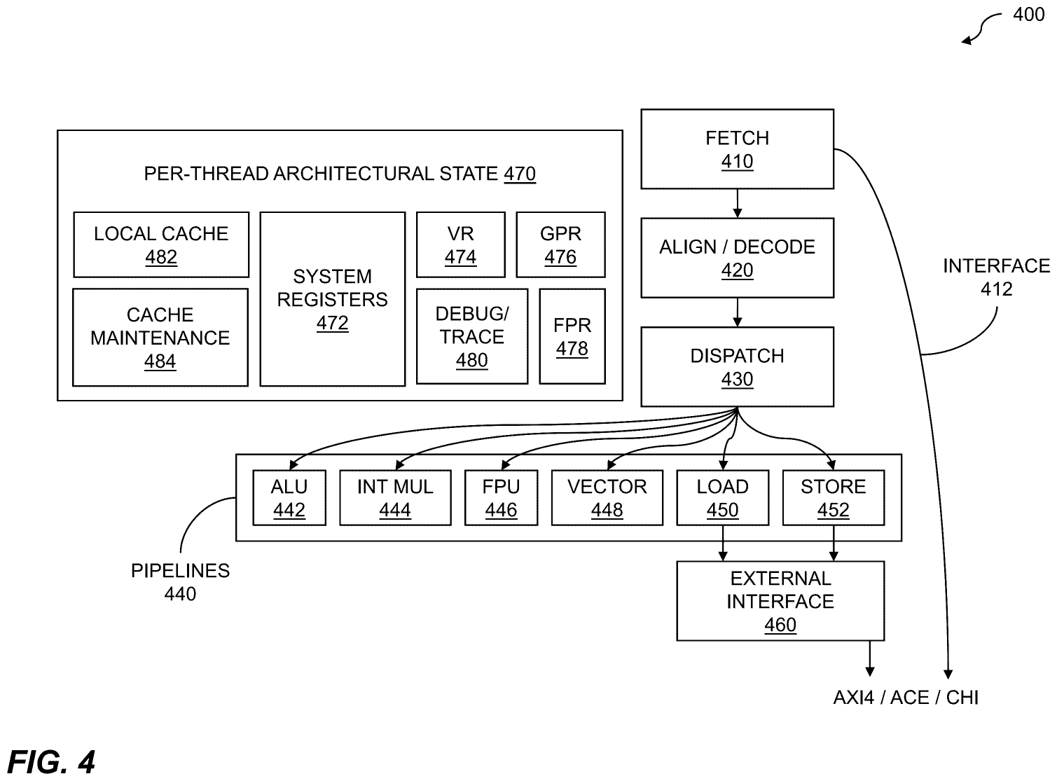

FIG. 4 is a block diagram of a pipeline. The use of one or more pipelines associated with a processor architecture can greatly enhance processing throughput. The processor architecture can be associated with one or more processor cores. The processing throughput can be increased because multiple operations can be executed in parallel. In embodiments, a processor core is accessed, where the processor core supports vector operations. The processor core enables vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

The blocks within the block diagram can be configurable in order to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. In embodiments, the width of the vector register file is 512 bits. Additional registers such as general-purpose registers (GPR) 476, and floating-point registers (FPR) 478 can be included. These registers can be used for general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

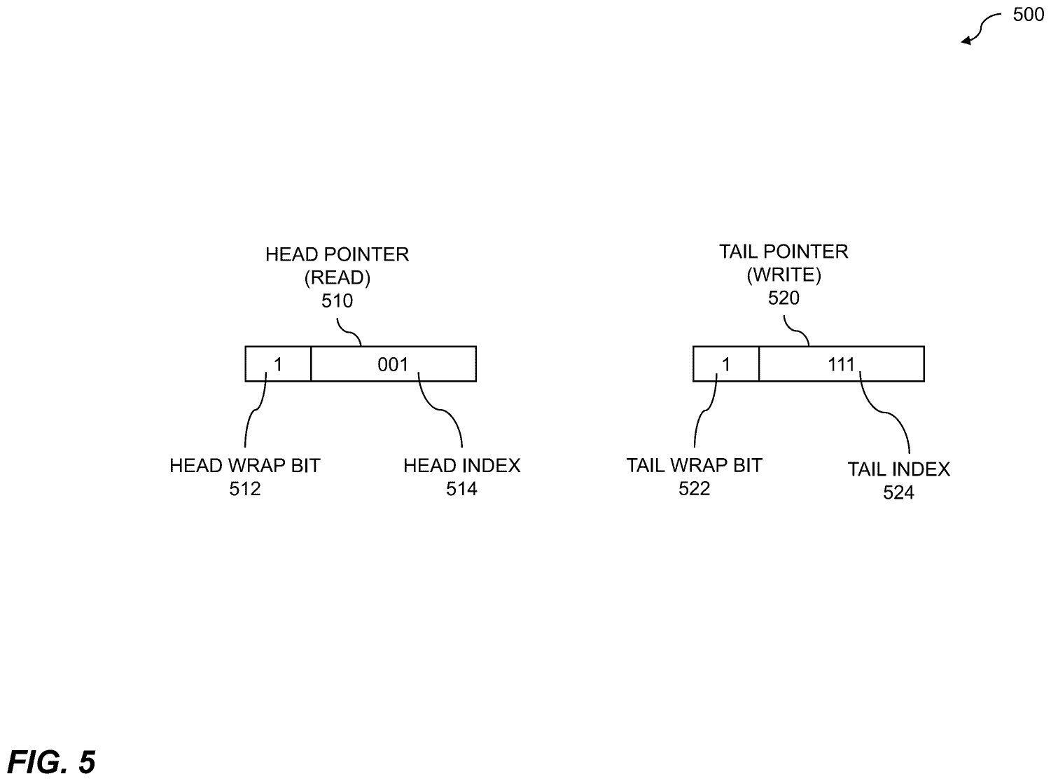

FIG. 5 is a block diagram of pointers for an 8-entry circular queue. The block diagram 500 can include a head pointer (read pointer) 510 that is used for determining where the next normal read is to occur. The head pointer 510 comprises a head index 514, and a head wrap bit 512. The head wrap bit 512 is a bit that is adjusted each time the head index 514 is moved from the end of the buffer that implements a circular queue to the top (beginning) of the buffer. The number of bits in the head index 514 can be based on the data width of the buffer. For an 8-bit width, three bits are used for the head index. In general, for a width of 2^{N} bits, the head index 514 is N bits.

The block diagram 500 can include a tail pointer (write pointer) 520 that is used for determining where the next write to the circular buffer is to occur. The tail pointer 520 comprises a tail index 524, and a tail wrap bit 522. The tail wrap bit 522 is a bit that is adjusted each time the tail index 524 is moved from the end of the buffer that implements a circular queue to the top (beginning) of the buffer. Similar to the head index 514, the number of bits in the tail index 524 can be based on the data width of the buffer. For an 8-bit width, three bits are used for the tail index. In general, for a width of 2^{N} bits, the tail index 524 is N bits.

In the block diagram 500, the head wrap bit 512 is part of the head pointer 510, and the tail wrap bit 522 is part of the tail pointer 520. However, in some embodiments, the head wrap bit and tail wrap bit may be implemented via a queue control register in a register file. As an example, with a data width of 256 bits, the head index and tail index are each 8 bits. As an alternative to having a 9-bit head pointer and 9-bit tail pointer, disclosed embodiments can implement the head wrap bit and tail wrap bit in the queue control register. In this way, the head pointer and tail pointer can be implemented as bytes.

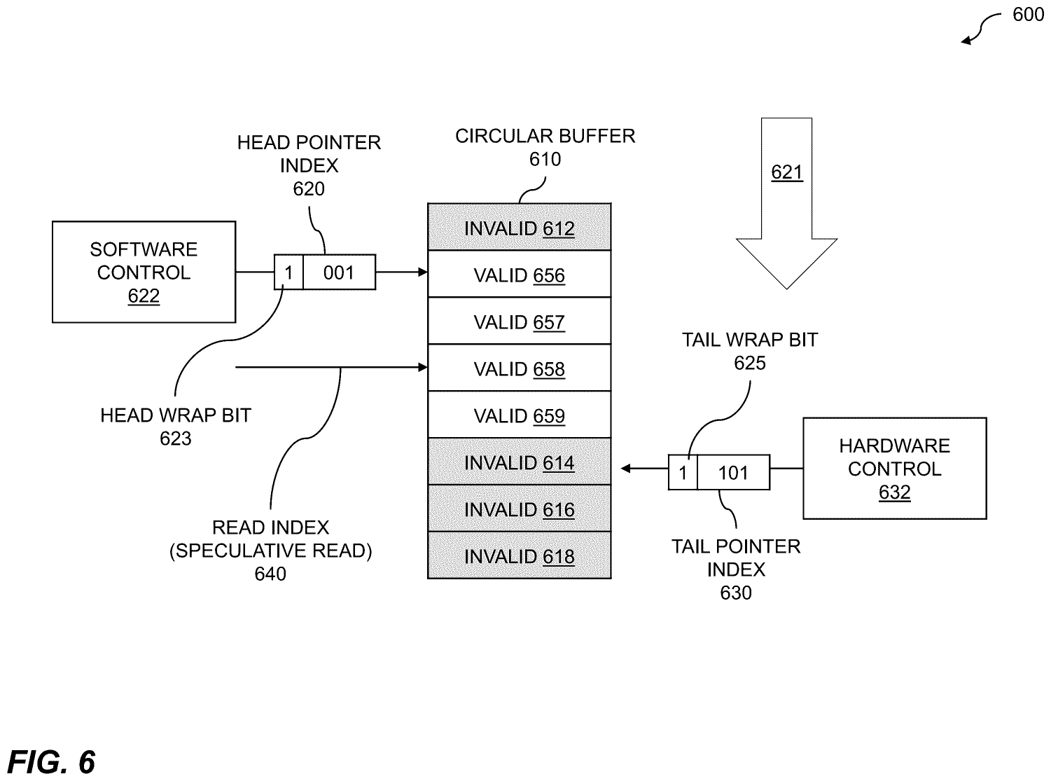

FIG. 6 is a block diagram of circular queue management with similar wrap bits. The block diagram 600 includes circular buffer 610. In the example of FIG. 6, the data width of circular buffer 610 is 8 bits. A head pointer index (head index) 620 has a value of 001, indicating that location 656, which is valid, is the next location to be dequeued during a read of a valid entry. In embodiments, the head pointer index is controlled by software control (agent) 622. In one or more embodiments, the software control 622 can be a software process, interrupt service routine (ISR), application, software task, software thread, daemon, service, and/or other suitable software construct. In embodiments, the software agent comprises a program running on a processor core. Similarly, a tail pointer index (tail index) 630 indicates the next location to be written to by hardware control (agent) 632. The hardware control 632 can include a processor core, a peripheral controller, a bus controller such as a PCIe controller, a DMA unit, a memory management unit (MMU), and so on. In embodiments, the hardware agent comprises a processor core. Embodiments can include writing, by a hardware agent, an entry in the circular queue. In the example of FIG. 6, the tail pointer index 630 has a value of 101 (binary), indicating that the next location to be written to location 614, which is invalid. Locations that are invalid are available to be written to. After a normal read is performed, the head pointer index 620 is incremented in the direction indicated by arrow 621. The software agent can control the incrementing. Thus, after a normal read, the head pointer index would have a value of 010 (binary) and would point to location 657. Similarly, after a write, the tail pointer index would increment in the direction indicated by arrow 621 and have a value of 110 (binary) and point to location 616. The incrementing of the tail index can be performed by the hardware agent. Thus, embodiments can include advancing, by the software agent, the head index by one or more positions in the single direction within the circular queue. In one or more embodiments, the read pointer can advance more than one entry at a time, in the direction indicated by arrow 621.

A read, which can be a speculative read, can be performed on any location within circular buffer 610. The read index 640 represents a speculative read for data at location 658. The speculative read can return data if the entry pointed to by the read index is valid. In embodiments, a valid range can be computed using the head wrap bit 623 and the tail wrap bit 625. When the head wrap bit 623 and the tail wrap bit 625 are of the same state (e.g., both the head wrap bit and the tail wrap bit have a value of 0, or both have a value of 1), then the range of valid values is from the location where the head pointer index 620 points, to the location with a value one less than the value pointed to by the tail pointer index 630. Accordingly, locations 656, 657, 658, and 659 are valid, and locations 612, 614, 616, and 618 are invalid. Thus, the result of the read at read index 640 returns the valid data at location 658. Thus, embodiments can include a read of the read entry within the circular queue. The read can be a speculative read. Thus, embodiments can include a speculative read of the read entry within the circular queue. In embodiments, the circular queue can determine the validity of the location specified by the read index without reading the circular queue. Multiple logical combinations can indicate that the location specified by the read index is valid. Embodiments include calculating that the head wrap bit is equal to the tail wrap bit, the read index is greater than or equal to the head index, and the read index is less than the tail index. Other embodiments include computing that the head wrap bit is not equal to the tail wrap bit and the read index is greater than or equal to the head index. Further embodiments include assessing that the head wrap bit is not equal to the tail wrap bit and the read index is less than the tail index.

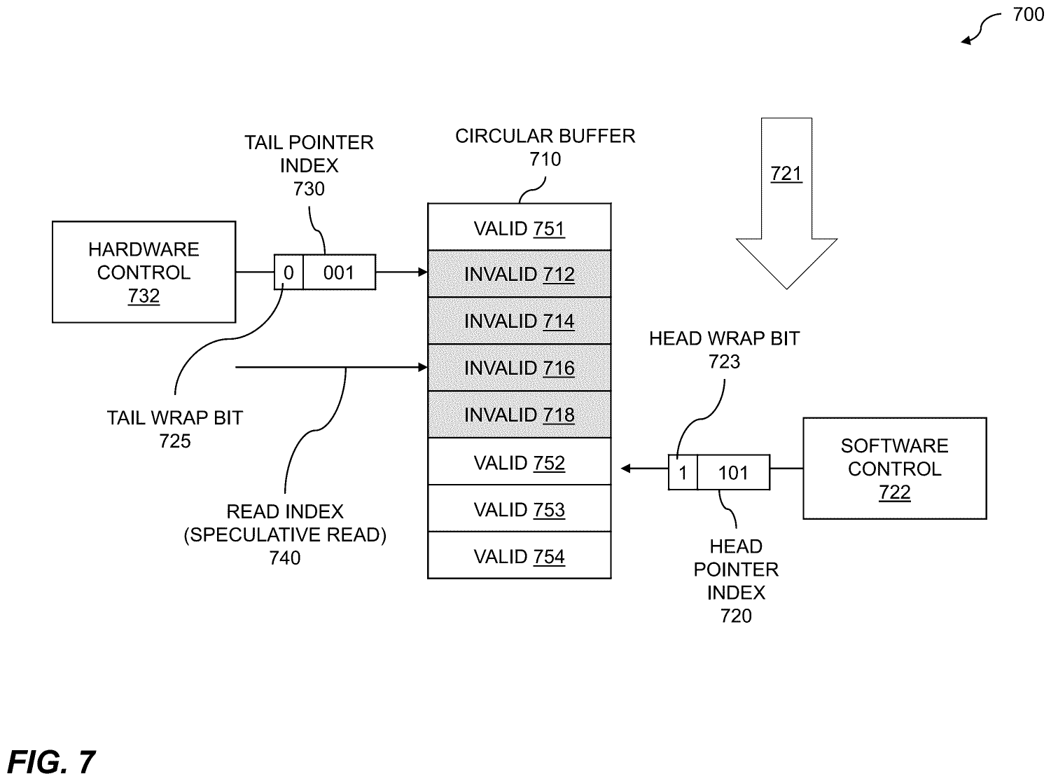

FIG. 7 is a block diagram of circular queue management with different wrap bits. The block diagram 700 includes circular buffer 710. In the example of FIG. 7, the data width of circular buffer 710 is 8 bits. A head pointer index 720 has a value of 101 (binary), indicating that location 752, which is valid, is the next location to be dequeued during a normal read. In embodiments, the head pointer index is controlled by software control (agent) 722. In one or more embodiments, the software control 722 can be a software process, interrupt service routine (ISR), application, software task, software thread, daemon, service, and/or other suitable software construct. Similarly, a tail pointer index 730 indicates the next location to be written to by hardware control 732. The hardware control 732 can include a processor core, a peripheral controller, a bus controller such as a PCIe controller, a DMA unit, a memory management unit (MMU), and so on. In the example of FIG. 7, the tail pointer index 730 has a value of 001 (binary), indicating that the next location to be written to is location 712 which is invalid. Locations that are invalid are considered empty and are available to be written to. After a normal read is performed, the head pointer index 720 is incremented in the direction indicated by arrow 721. Thus, after a normal read, the head pointer index would have a value of 110 (binary) and would point to location 753. Similarly, after a write, the tail pointer index would increment in the direction indicated by arrow 721 and have a value of 010 (binary) and point to location 714.

In contrast to the example shown in FIG. 6, the example shown in FIG. 7 depicts a case where the tail pointer index 730 has a value (001) that is less than the value (101) of the head pointer index 720. The case of the tail pointer index having a value less than that of the head pointer index can occur when the tail pointer index wraps to the beginning of the buffer, and the head pointer index has not yet wrapped to the beginning. As shown in FIG. 7, the tail wrap bit 725 has a different value than the head wrap bit 723. When the head wrap bit 723 and the tail wrap bit 725 have different values, the range of valid values includes the locations corresponding to values less than the tail pointer index 730, and the locations corresponding to values greater than or equal to the head pointer index 720. Accordingly, locations 751, 752, 753, and 754 are valid, and locations 712, 714, 716, and 718 are invalid.

A read, which can be a speculative read, can be performed on any location within circular buffer 710. The read index 740 represents a speculative read for data at location 716. The speculative read can return data if the entry pointed to by the read index is valid. Thus, the result of the read at read index 740 returns an invalid indication since location 716 is invalid. The determination of invalidity can be quickly determined for any given location within circular buffer 710 by analyzing the state of the tail pointer index 730, tail wrap bit 725, head pointer index 720, and head wrap bit 723. When the head pointer advances to location 754, the subsequent normal read results in the head pointer index 720 pointing to location 751, with the head wrap bit 723 toggling. Embodiments can include adjusting the head wrap bit, wherein the advancing causes the head index to point to a top of the circular queue.

In the case where the tail pointer index and head pointer index both refer to the same location, the value of the head wrap bit and tail wrap bit are used to determine the validity. If the head wrap bit and the tail wrap bit are unequal, the data that the location being referred to by the head pointer index is valid. If the head wrap bit and the tail wrap bit are equal, the data that the location being referred to by the head pointer index is invalid (e.g., treated as available/empty). In embodiments, the circular queue can determine the validity of the location specified by the read index without reading the circular queue. Multiple logical combinations can indicate that the location specified by the read index is valid. Embodiments include calculating that the head wrap bit is equal to the tail wrap bit, the read index is greater than or equal to the head index, and the read index is less than the tail index. Other embodiments include computing that the head wrap bit is not equal to the tail wrap bit and the read index is greater than or equal to the head index. Further embodiments include assessing that the head wrap bit is not equal to the tail wrap bit and the read index is less than the tail index.

FIG. 8 is a block diagram of valid logic for circular queue management with nondestructive speculative reads. The block diagram 800 includes circular buffer 810. The circular buffer 810 has a data width. In one or more embodiments, the data width can be 8 bits, 16 bits, 32 bits, 64 bits, 128 bits, 256 bits, or any other suitable data width. The circular buffer 810 includes multiple locations (entries), indicated generally as 811. Embodiments can include hundreds, thousands, or multiple millions of locations. As examples, a circular buffer can include 1024 locations, 65,536 locations, or any other suitable number of locations. The read index 820, head wrap bit 822, head pointer index 828, tail pointer index 824, and tail wrap bit 826 are input to valid logic 830. Valid logic 830 can include multiple logic gates for interpreting the information and values that are input to the valid logic 830. The interpretation can include determining validity of a location within circular buffer 810 that is specified by read index 820.

The read index 820 can correspond to a read of the circular queue, which can be a speculative read. The speculative read may be performed as part of data prefetching, out-of-order (OoO) instruction execution, and so on. The valid logic 830 makes a determination of validity of the data in the circular buffer 810 at the location specified by read index 820. In embodiments, the circular queue can determine the validity of the location specified by the read index without reading the circular queue. Multiple logical combinations can indicate that the location specified by the read index is valid. Embodiments include calculating that the head wrap bit is equal to the tail wrap bit, the read index is greater than or equal to the head index, and the read index is less than the tail index. Other embodiments include computing that the head wrap bit is not equal to the tail wrap bit and the read index is greater than or equal to the head index. Further embodiments include assessing that the head wrap bit is not equal to the tail wrap bit and the read index is less than the tail index.

In response to determining that the data is valid, such as the scenario depicted in FIG. 6, the buffer entry data 850 is copied from circular buffer 810 via multiplexor (mux) 835, and is provided as data out 860 to the requesting software control entity. The software control can include a software process, software task, thread, application, script, interrupt service routine (ISR), and so on. In the case of a speculative read, the value of the head pointer index 828 remains constant when the buffer entry data 850 is copied and provided as data out 860. Accordingly, the read of the buffer entry data 850 is nondestructive, in that the location specified by read index 820 remains valid. In response to determining that the data is invalid, such as the scenario depicted in FIG. 7, an invalid data indication 840 is provided via mux 835, and provided as data out 860 to the requesting software control entity. In one or more embodiments, the invalid data indication can include a reserved bit pattern. For example, for a circular buffer 810 having a data width of 8 bits, a binary pattern of 10101010 (binary) can serve as a reserved value indicating invalid data. Accordingly, with disclosed embodiments, there is no need to examine the actual contents of circular buffer 810 in order to determine the invalidity and provide the invalid data indication 840, thereby providing improved processor performance when speculative reads reference invalid data within the circular buffer 810. The software control can be configured to interpret the reserved bit pattern as an indication of invalid data. In one or more embodiments, the reserved bit pattern can be specified via a register.

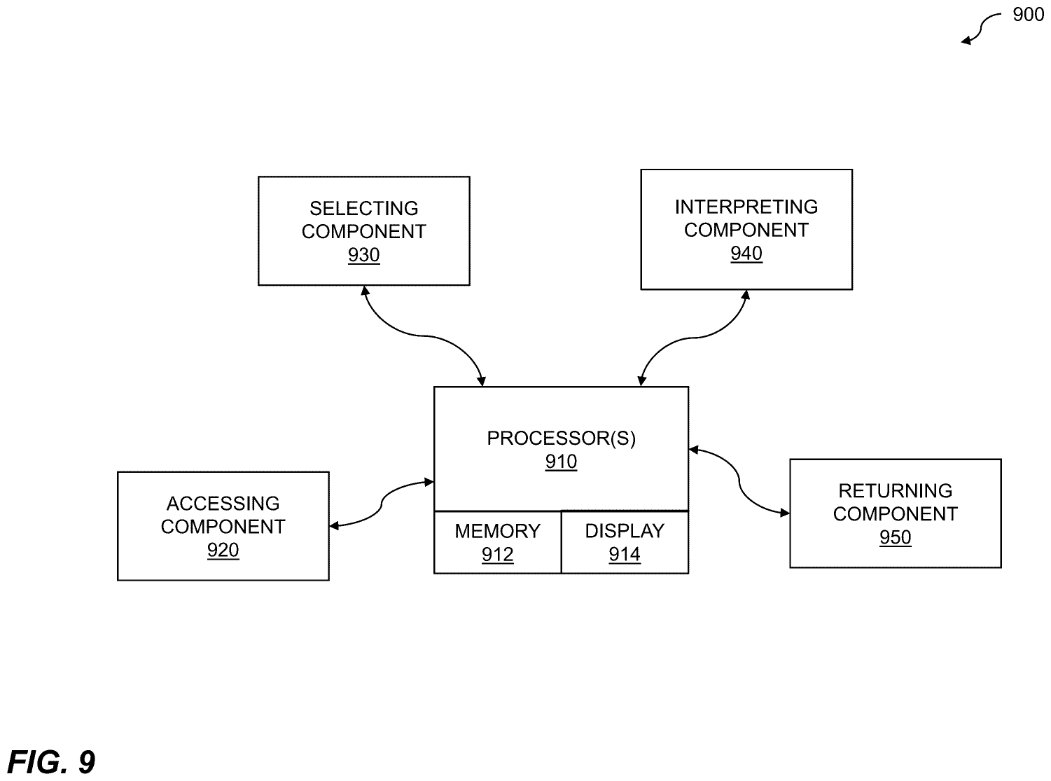

FIG. 9 is a system diagram for circular queue management with nondestructive speculative reads. The system 900 can include one or more processors 910, which are coupled to a memory 912 which stores instructions. The system 900 can further include a display 914 coupled to the one or more processors 910 for displaying data. The memory 912 can include instructions, that when executed by the one or more processors 910 can configure the one or more one or more processors to: access a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue; select, by a software agent, a read entry within the circular queue, wherein the read entry is associated with a read index; interpret a validity of the read entry, wherein the interpreting is based on the head wrap bit, the tail wrap bit, the read index, the head index, and the tail index; and return, by the circular queue, to the software agent, an invalid signal, wherein the read entry is not modified, and wherein the read entry was interpreted, by the interpreting, as invalid.

The system 900 can include an accessing component 920. The accessing component 920 can include functions and instructions for accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue. The circular queue can have multiple entries. In embodiments, there can be hundreds, thousands, or multiple millions of entries. The circular queue has a data width. The data width can be any number of bits. In one or more embodiments, each location of the circular queue can include information bits along with data bits.

The system 900 can include a selecting component 930. The selecting component 930 can include functions and instructions for selecting, by a software agent, a read entry within the circular queue, wherein the read entry is associated with a read index. The software agent can include an application, task, script, process, thread, interrupt service routine, and/or other suitable software agent. The software agent can be configured to interpret a specified reserved bit pattern as an invalid data indication. In one or more embodiments, the specifying of the reserved bit pattern can be performed by specifying the reserved bit pattern in a configuration file, in a general-purpose register, in a special purpose register, specified at compile time, and so on.

The system 900 can include an interpreting component 940. The interpreting component 940 can include functions and instructions for interpreting a validity of the read entry, wherein the interpreting is based on the head wrap bit, the tail wrap bit, the read index, the head index, and the tail index. In embodiments, a valid range is specified by the tail wrap bit and the head wrap bit having the same value, and queue locations outside of the valid range are determined to be invalid. In embodiments, an invalid range is specified by the tail wrap bit and the head wrap bit having a different value, and queue locations outside of the invalid range are determined to be valid.

The system 900 can include a returning component 950. The returning component 950 can include functions and instructions for returning, by the circular queue, to the software agent, an invalid signal, wherein the read entry is not modified, and wherein the read entry was interpreted, by the interpreting, as invalid. The returning can include use of valid logic and a multiplexor (mux) to return data from the circular queue to the software agent when the data is determined to be valid. The returning can include use of valid logic and a multiplexor (mux) to return an indication of invalidity to the software agent when the data is determined to be invalid. In one or more embodiments, the indication of invalidity can include a reserved bit pattern.

The system 900 can include a computer program product embodied in a non-transitory computer readable medium for instruction execution. In embodiments, the computer program product comprises code which causes one or more processors to generate semiconductor logic for: accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue; selecting, by a software agent, a read entry within the circular queue, wherein the read entry is associated with a read index; interpreting a validity of the read entry, wherein the interpreting is based on the head wrap bit, the tail wrap bit, the read index, the head index, and the tail index; and returning, by the circular queue, to the software agent, an invalid signal, wherein the read entry is not modified, and wherein the read entry was interpreted, by the interpreting, as invalid.

The system 900 can include a computer system for instruction execution comprising: a memory which stores instructions; one or more processors coupled to the memory wherein the one or more processors, when executing the instructions which are stored, are configured to: access a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue; select, by a software agent, a read entry within the circular queue, wherein the read entry is associated with a read index; interpret a validity of the read entry, wherein the interpreting is based on the head wrap bit, the tail wrap bit, the read index, the head index, and the tail index; and return, by the circular queue, to the software agent, an invalid signal, wherein the read entry is not modified, and wherein the read entry was interpreted, by the interpreting, as invalid.

As can now be appreciated, disclosed embodiments provide improvements in circular queue management with nondestructive speculative reads. Disclosed embodiments enable fast and efficient determination of validity of a given location within the circular queue without the need to examine the queue itself. This feature provides improved performance, and furthermore enables speculative reads that return valid data to a software agent in cases where the speculative read accesses a location with valid data. In cases where the software agent performs a speculative read access at a location with invalid data, an invalid data indication can be returned to the software agent. Thus, disclosed embodiments provide efficient techniques for performing speculative reads on circular queues, which has benefit in many applications, such as audio and video decoding, VOIP (Voice over IP) applications, and many other data-intensive and/or time-critical applications. These benefits can include improved throughput. By prefetching data, the software agent can overlap the latency of memory accesses with other processing tasks, leading to improved overall throughput. In certain cases, prefetching can help smooth out irregular access patterns, leading to more predictable performance and reduced likelihood of cache misses. Additionally, by reducing the time spent waiting for data, prefetching can lead to lower energy consumption, especially in systems where power efficiency is a concern. Thus, disclosed embodiments enable improved performance and efficiency for implementation of circular queues, which can be beneficial for many cases, especially in scenarios where data access patterns are predictable or where minimizing latency is critical.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods (processor-implemented methods) may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for managing a queue comprising:
accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue;
selecting, by a software agent, a read entry within the circular queue, wherein the read entry is associated with a read index;
interpreting a validity of the read entry, wherein the interpreting is based on the head wrap bit, the tail wrap bit, the read index, the head index, and the tail index; and
returning, by the circular queue, to the software agent, an invalid signal, wherein the read entry is not modified, and wherein the read entry was interpreted, by the interpreting, as invalid.

2. The method of claim 1 further comprising sending, by the circular queue, to the software agent, data within the read entry, wherein the read entry is not modified, and wherein the read entry was interpreted, by the interpreting, as valid.

3. The method of claim 2 further comprising calculating that the head wrap bit is equal to the tail wrap bit, the read index is greater than or equal to the head index, and the read index is less than the tail index.

4. The method of claim 2 further comprising computing that the head wrap bit is not equal to the tail wrap bit and the read index is greater than or equal to the head index.

5. The method of claim 2 further comprising assessing that the head wrap bit is not equal to the tail wrap bit and the read index is less than the tail index.

6. The method of claim 1 further comprising writing, by a hardware agent, an entry in the circular queue.

7. The method of claim 6 wherein the hardware agent comprises a processor core.

8. The method of claim 6 wherein the writing is based on the tail index.

9. The method of claim 8 further comprising setting one or more information bits.

10. The method of claim 9 wherein the one or more information bits include a type of data.

11. The method of claim 10 wherein the type of data is read data or write data.

12. The method of claim 10 wherein the type of data is atomic data.

13. The method of claim 10 wherein the type of data is a message.

14. The method of claim 8 further comprising incrementing the tail index.

15. The method of claim 14 further comprising adjusting the tail wrap bit, wherein the incrementing causes the tail index to point to a top of the circular queue.

16. The method of claim 1 wherein the selecting includes advancing, by the software agent, the head index by one or more positions in the single direction within the circular queue.

17. The method of claim 16 further comprising restricting the head index, wherein the restricting prevents the head index from moving past the tail index.

18. The method of claim 16 further comprising adjusting the head wrap bit, wherein the advancing causes the head index to point to a top of the circular queue.

19. The method of claim 1 wherein the selecting comprises a read of the read entry within the circular queue.

20. The method of claim 1 wherein the selecting comprises a speculative read of the read entry within the circular queue.

21. The method of claim 1 wherein the software agent comprises a program running on a processor core.

22. A computer program product embodied in a non-transitory computer readable medium for instruction execution, the computer program product comprising code which causes one or more processors to generate semiconductor logic for:
accessing a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue;
selecting, by a software agent, a read entry within the circular queue, wherein the read entry is associated with a read index;
interpreting a validity of the read entry, wherein the interpreting is based on the head wrap bit, the tail wrap bit, the read index, the head index, and the tail index; and
returning, by the circular queue, to the software agent, an invalid signal, wherein the read entry is not modified, and wherein the read entry was interpreted, by the interpreting, as invalid.

23. A computer system for instruction execution comprising:
a memory which stores instructions;
one or more processors coupled to the memory wherein the one or more processors, when executing the instructions which are stored, are configured to:
access a circular queue, wherein the circular queue comprises a plurality of entries, wherein the circular queue includes a head pointer and a tail pointer, wherein the head pointer comprises a head wrap bit and a head index, wherein the tail pointer comprises a tail wrap bit and a tail index, and wherein the head pointer and the tail pointer move independently in a single direction within the circular queue;
select, by a software agent, a read entry within the circular queue, wherein the read entry is associated with a read index;
interpret a validity of the read entry, wherein the interpreting is based on the head wrap bit, the tail wrap bit, the read index, the head index, and the tail index; and
return, by the circular queue, to the software agent, an invalid signal, wherein the read entry is not modified, and wherein the read entry was interpreted, by the interpreting, as invalid.
